(19) United States
(12) Patent Application Publication
(10) Pub. No.: US 2006/0000070 A1
(43) Pub. Date: Jan. 5, 2006

(54) Apparatus and process for spinning and laying a synthetic yarn sheet for the production of non-wovens

(75) Inventor: Anton Mooshammer, Wankendorf (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Saurer GmbH & Co. KG

(21) Appl. No.: 11/222,472

(22) Filed: Sep. 8, 2005

Related U.S. Application Data
(63) Continuation of application No. PCT/EP04/02494, filed on Mar. 11, 2004.

(30) Foreign Application Priority Data
Mar. 15, 2003 (DE) 103 11 439.4

(51) Int. Cl. B32B 3/06

(52) U.S. Cl. 28/102

(57) ABSTRACT

An apparatus and process for producing a non-woven fabric or mat, wherein a downwardly advancing sheet of polymeric filaments is produced by a melt spinning device, and a draw-off device serves to withdraw the sheet from the spinning device and advance the sheet into a collecting gap which is formed by two feed rollers which are positioned a short distance above a perforated support. In order to obtain a desired configuration on both surfaces of the web, the collecting gap is extended by two opposing feed belts which cooperate with the feed rollers to shape the sheet upstream of the perforated support.

### CROSS REFERENCE TO RELATED APPLICATION

The present application is a continuation of international application PCT/EP2004/002494, filed 11 Mar., 2004, and which designates the U.S. The disclosure of the referenced application is incorporated herein by reference.

### BACKGROUND OF THE INVENTION

The present invention relates to a process and apparatus for spinning and laying a synthetic yarn sheet for the production of non-woven fabrics or mats.

In the production of non-woven fabrics or mats, freshly spun endless filaments are laid on a perforated belt or a perforated drum, which works together with a suction device in order to obtain uniform laying of the filaments and thus a uniform non-woven formation, and to effect a cooling of the melt-spun filaments. The non-wovens produced through the laying of filaments are as a rule made flat and through the application of one side on the perforated support the surface quality is made different on the lower side from the upper side.

In order to improve the forming of non-wovens, DE 42 04 366 A1 discloses a prior device and process in which the yarn sheet after the spinning and before the laying on the perforated support, is first fed through a collecting gap formed between two feed rollers. Therein the feed rollers are used essentially to spread the yarn sheet. The formation of the non-woven is done on the perforated support. With this, the distribution of the individual filaments within the non-woven can be influenced. The forming of the non-woven is however still influenced. The forming of the non-woven is however still determined by the single side application on the perforated support as before. Thus as a rule, one side of the non-woven is always smooth and the opposite side has a more or less structured form of a wave.

It is accordingly an objective of the invention to provide an apparatus and a process of the type stated initially with which a homogeneous, uniformly formed non-woven fabric or mat can be produced.

An additional objective of the invention lies in providing an apparatus and a process with which a non-woven having as high a volume as possible can be produced.

### SUMMARY OF THE INVENTION

The invention deviates from the known practice in which the production of the non-woven is conducted essentially by laying a sheet of filaments on the horizontally aligned perforated support. In contrast, the present invention uses the collection of the yarn sheet right after the drawing off from a spinning device to form a non-woven oriented laid material. For this, the yarn sheet is fed through a collecting gap which is formed by two feed belts disposed opposite one another.

The feed belts can be driven at a surface speed where the feed rate of the feed belts is less than the draw-off rate of the yarn sheet. Thus, for example, the laying of the yarn sheet in the collecting gap can be influenced by the feed rate of the feed belts in such a manner that, for example, higher laying densities can be produced.

The invention distinguishes itself in particular by the fact that the non-woven can be formed with two sides. Furthermore, the invention has the advantage that a spatial laying structure of the filaments in the non-woven is produced, said laying structure being suited in particular to the production of voluminous non-wovens. In this case the thickness of the non-woven can be determined in a simple manner by the width of the collecting gap.

In order to obtain an oriented laying already in the collection of the yarn sheet, in a particularly advantageous extension of the invention, the feed rollers are made with a feed jacket permeable to air and with a suction device disposed in the interior of the feed jacket. In this case the suction device suctions a segmental circumferential section of the feed jacket in the area of the entrance to the collecting gap. In this way there is a uniform distribution of the filaments on the application surfaces of the feed rollers. In this case the feed rollers and the feed belts are preferably driven at the same feed rate and form a common collecting gap.

Through the invention's advantageous embodiment in which the suction device is formed in such a manner that it can be displaced in the circumferential direction of the feed rollers, the start of the forming of the non-woven can be offset to a desired area.

Along with this a sufficient and intensive suction flow is achieved by the feed jacket of the feed rollers comprising an open surface of >75%, preferably >90%.

Advantageously the orientation of the yarn sheet as well as the forming of the non-woven to be formed can be influenced in such a manner that the suctioning of the application surfaces is done at different intensities at the entrance of the collecting gap. For this, the suction devices are formed so that they can be controlled independently of one another.

An additional possibility for influencing the laying of the yarn sheet by the suction flow is provided by the feed jacket of the invention, which comprises, in its interior below an exterior application surface, partition walls which are each aligned in the radial direction. Such partition walls influence the course of the flow of the suctioned air flow and thus the collecting and laying of the yarn sheet.

Through the possibility of changing both feed rollers in their horizontal distance from one another, a desired thickness or a desired volume of the non-woven can be set.

By changing the positions of the feed rollers in the running direction of the yarn sheet, the spinning length can in addition be set to a desired optimum.

Basically the feed rollers and the feed belts can be formed and driven by separate means. In practice however a particularly advantageous embodiment of the invention has proven itself, in which the feed belts are formed so that they are permeable to gas and, as endless belts, each encircle one of the feed rollers and a deflecting roller which works together with the feed roller in question. In this way, one ensures continuous collecting of the filaments, laying of the filaments on a perforated support, and transporting of the resulting fabric or mat on a perforated support. In particular, it is possible to realize good and stable forming of the non-woven of both sides until the perforated support is reached.

The forming can also be advantageously supported by the feed belts being disposed relative to one another in such a manner that the collecting gap has a greater width at its entrance than at its exit. Thus, the thickness of the non-woven is determined by the width of the collecting gap at its exit.

For a reliable transfer of the non-woven from the feed belts to the perforated support, the embodiment of the invention is particularly preferred in which the perforated support includes a suction device in the area of the exit of the feed belts so that a transfer zone of the perforated support can be suctioned.

The perforated support is preferably formed by a running collecting belt which is responsible for the transport of the non-woven for further treatment and further processing.

### BRIEF DESCRIPTION OF THE DRAWINGS

Additional advantages of the process according to the invention and the apparatus according to the invention are described in more detail in the following, with the aid of several embodiments as shown in the accompanying figures, in which:

FIG. 1 is a schematic view of a first embodiment of the device according to the invention,

FIG. 2 is a schematic cross-sectional view of the embodiment of FIG. 1, without showing a spinning device and draw-off device,

FIG. 3 is a schematic cross-sectional view of an additional embodiment of the device according to the invention without showing a spinning device and draw-off device, and

FIG. 4 is a schematic cross-sectional view of an additional embodiment of the device according to the invention, without showing a spinning device and draw-off device.

### DETAILED DESCRIPTION OF THE PREFERRED EMBODIMENTS

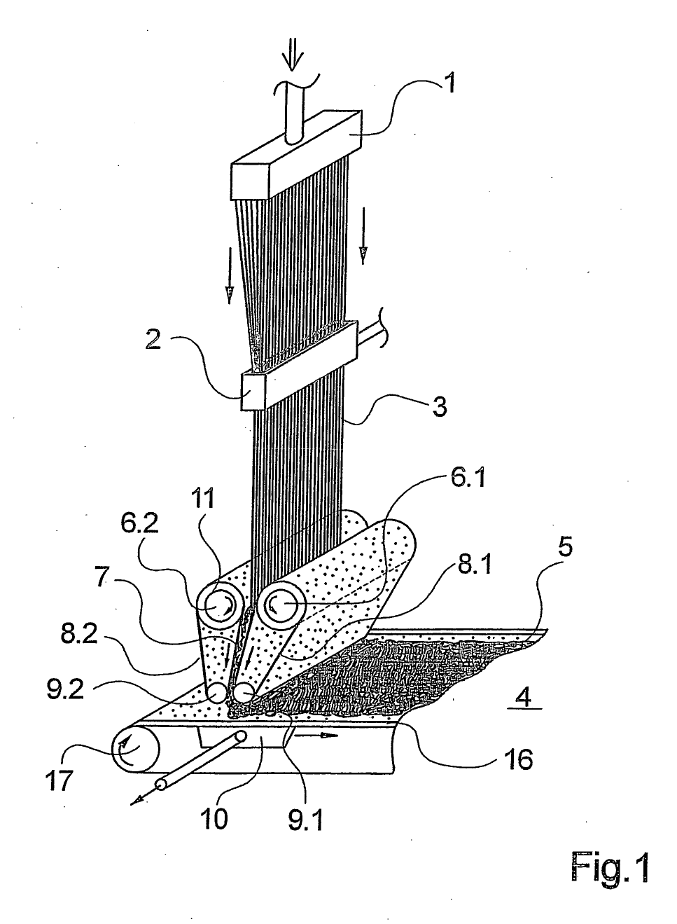

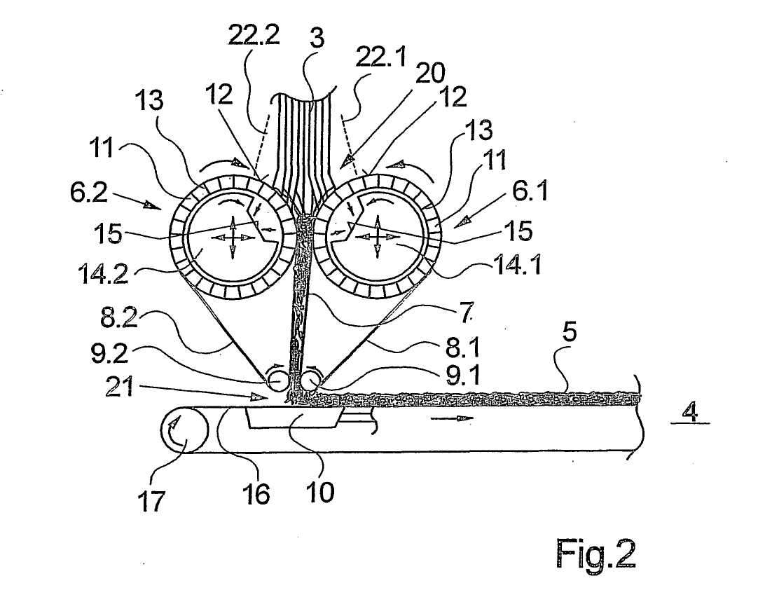

In FIG. 1 and FIG. 2 a first embodiment of the apparatus according to the invention for carrying out the process according to the invention is represented schematically. FIG. 1 shows a schematic view of the complete device. In FIG. 2 a cross-sectional view is shown schematically, where representation of the spinning device and the draw-off device is omitted. In the absence of an express reference to one of the figures being made, the following description applies to both figures.

The device according to the invention comprises spinning device 1, through which a yarn sheet 3 consisting of a plurality of individual filaments are melt spun. In this case the spinning device 1 can comprise means for melting polymeric granules, means for feeding a polymer melt, means for conveying a polymer melt, means for extruding the polymer melt, and means for cooling the freshly extruded filaments. Spinning devices of this type are generally known, so that a detailed representation and description can be omitted.

Below the spinning device 1 a draw-off device 2 is provided through which the yarn sheet 3 is drawn off from the spinning device 1 and accelerated. As draw-off device 2, suction nozzles or suction channels, preferably compressed air-driven, are used. In principle however, any of the known draw-off systems for drawing off and accelerating a yarn sheet can be used.

Below the draw-off device 2 two feed rollers 6.1 and 6.2 are disposed in parallel adjacent to one another in such a manner that a collecting gap 7 is formed between the feed rollers 6.1 and 6.2. The feed rollers 6.1 and 6.2 thus represent an entrance 20 to the collecting gap 7.

The feed rollers 6.1 and 6.2 are each encircled by a feed belt 8.1 and 8.2. The feed belts 8.1 and 8.2 are formed to be endless and are each fed in an extension of the collecting gap 7 up to a deflecting roller 9.1 and 9.2. As endless belts the feed belt 8.1 is thus led around the feed roller 6.1 and the deflecting roller 9.1 while the feed belt 8.2 is led around the feed roller 6.2 and the deflecting roller 9.2. In so doing, the feed belts 8.1 and 8.2 extend essentially over the entire width of the feed rollers 6.1 and 6.2. The deflecting rollers 9.1 and 9.2 form an exit 21 from the collecting gap 7, which is disposed at a short distance from a perforated support 4 which extends in the horizontal direction. The perforated support 4 is implemented as a collecting belt 16, which is conducted or driven via a belt roller 17. The collecting belt 16 has a width which corresponds at least to the width of the feed belts 8.1 and 8.2. In the area of the exit 21 a suction device 10 is disposed adjacent the collecting belt 16, by means of which, in a transfer zone for picking up a non-woven, a suction flow which penetrates the collecting belt 16 can be generated.

In the embodiment represented in FIGS. 1 and 2 of the device according to the invention, a yarn sheet 3 is spun by means of the spinning device 1. The yarn sheet 3 is drawn off by the draw-off device 2 and fed with acceleration to the feed rollers 6.1 and 6.2.

As is shown in FIG. 2, the feed rollers 6.1 and 6.2 each comprise in their interior a suction device 14.1 and 14.2. The suction devices 14.1 and 14.2 each have a suction opening 15 which is turned toward the entrance 20 to the collecting gap 7. The suction opening 15 of the suction device 14.1 or 14.2 is formed in such a manner that the feed jacket 11 of the feed rollers 6.1 and 6.2 in question is suctioned in a circumferential section in the form of a segment. The segment like circumferential section is held in the area of the entrance 20 to the collecting gap 7. Along with this, the suction openings 15 can be displaced by rotation within the feed rollers 6.1 and 6.2, in order to change the circumferential section to be suctioned. Each of the feed rollers 6.1 and 6.2 has an identical structure of the feed jacket 11. The feed jacket 11 consists of an exterior application surface 12, which is formed by the respective feed belts 8.1 and 8.2. Below the application surface 12 the feed jacket 11 comprises in its interior several partition walls 13 aligned at a distance from one another and extending in the radial direction. The partition walls 13 can be formed to be straight, curved, or inclined so that by turning of the feed jacket 11 an additional effect of the suction flow is possible. The feed belts 8.1 and 8.2 are formed so as to be permeable to gas, where the open surface of the feed belts 8.1 and 8.2 is in the range of 75%-98%.

The feed rollers 6.1 and 6.2 and the deflecting rollers 9.1 and 9.2 are held in such a manner that they can be moved, in a frame (not shown). In this case the feed rollers 6.1 and 6.2 as well as the deflecting rollers 9.1 and 9.2 can be displaced to adjust the width of the collecting gap 7 in the horizontal direction.

Likewise, a vertical displacement of the feed rollers 6.1 and 6.2 and the deflecting rollers 9.1 and 9.2 is possible in order to change in particular the distance between the draw-off device 2 and the collecting gap 7. In this case, between the feed rollers 6.1 and 6.2 and the respective deflecting rollers 9.1 and 9.2, a belt-tensioning device can advantageously act, through which a desired tension of the feed belts 8.1 and 8.2 continues to be ensured.

After the yarn sheet 3 is fed with acceleration through the draw-off device 2 in the direction of the collecting gap 7 the individual filaments of the yarn sheet 3 are, due to the suction flow, laid on the application surfaces 12 of the feed rollers 6.1 and 6.2 or the feed belts 8.1 and 8.2 and fed into the collecting gap 7. In so doing, a non-woven 5 is formed. The feed belts 8.1 and 8.2 are driven via the feed rollers 6.1 and 6.2 in the running direction of the filaments at a predetermined feed rate. The feed rates of the feed belts 8.1 and 8.2 are preferably made to be identical and essentially less than the draw-off rate generated by the draw-off device 2. By the relationship between the draw-off rate and the feed rate the density of the fiber non-wovens 5 can essentially be defined. The greater the difference between the draw-off rate and the feed rate is, the higher the density of the non-woven 5 for a constant collecting gap 7.

Collected and laid in the entrance 20 to the collecting gap 7, the filaments of the yarn sheet 3 produce a non-woven 5 formed with two sides. Due to the bilateral suctioning of the application surface 12, a spatial laying structure of the filaments within the non-woven 5 results so that a voluminous non-woven 5 is formed. The volume of the fiber non-woven 5 can be set essentially by the width of the collecting gap 7.

The non-woven 5 produced in this manner is fed via the feed belts 8.1 and 8.2 to the exit 21 and laid on the collecting belt 16. Due to the suction device 10 disposed at the collecting belt 16 there is a controlled and uniform laying of the filaments on the collecting belt 16. The belt rate of the collecting belt 16 is essentially equal to the feed rate of the feed belts 8.1 and 8.2 so that no additional compression or loosening of the non-woven develops. It is however possible to achieve special effects in the non-woven by different settings of the belt rate of the collecting belt 16 in relationship to the feed rates of the feed belts 8.1 and 8.2. The non-woven 5 is transported by the collecting belt 16 for further processing and further treatment.

The device according to the invention and the process according to the invention are thus particularly suitable for steadily producing voluminous non-wovens formed with two sides. Here all the customary types of polymers, e.g., polyester, polyamide, polypropylene, or modifications and mixtures of these types of polymers, can be used. A non-woven with predetermined density, uniform surfaces, and three-dimensional orientation can be produced.

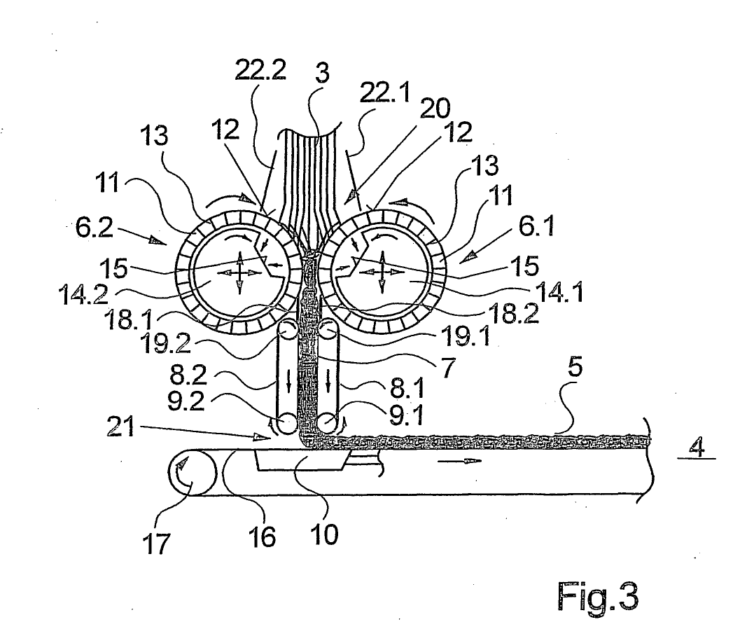

In FIG. 3 an additional embodiment of the device according to the invention is represented schematically in a cross-sectional view. In the embodiment represented in FIG. 3 the representation of the spinning device of the draw-off device is omitted. To that extent, reference is made to the previous embodiment. Likewise, the formation of the perforated support 4 is identical to the previous embodiment. For this, reference is made to the description of the previous embodiment.

To collect and lay the yarn sheet, the embodiment comprises two feed rollers 6.1 and 6.2 which form the entrance 20 to the collecting gap 7. Two feed belts 8.1 and 8.2 are disposed after the feed rollers 6.1 and 6.2, each of said feed belts being led over a drive roller 19.1 and 19.2 and a deflecting roller 9.1 and 9.2. Between the feed rollers 6.1 and 6.2 as well as between the feed belts 8.1 and 8.2 the collecting gap 7 is formed. The transfer area of the collecting gap 7 between the feed rollers 6.1 and 6.2 and the feed belts 8.1 and 8.2 is bordered by two guide plates 18.1 and 18.2 disposed opposite one another.

The feed rollers 6.1 and 6.2 are identical in their structure to the previous embodiment so that at this point reference can be made to the previous description. For collecting the yarn sheet 3 baffles 22.1 and 22.2 are disposed at the sides of the entrance 20 to the feed rollers 6.1 and 6.2, where the suctioning of the ambient air is prevented by the baffles. Baffles 22.1 and 22.2 of this type can preferably be formed in such a manner that a direct transfer from the draw-off device to the feed rollers can be shielded from the environment. Baffles of this type can, for example, also be used in the embodiment according to FIG. 1.

The collecting and laying of the yarn sheet in the collecting gap 7 is done in the same manner as already explained in the previous embodiment. In contradistinction to the previous embodiment according to FIGS. 1 and 2 however the possibility now exists that the feed rate of the feed rollers 6.1 and 6.2 and the feed rate of the feed belts 8.1 and 8.2 can be set to be different. Thus, for example, the density of the resulting non-woven can be increased by a lower feed rate of the feed belts 8.1 and 8.2. It is however also possible to achieve a loosening of the fiber non-woven by the feed rate of the feed belts 8.1 and 8.2 being set higher than the feed rate of the feed rollers 6.1 and 6.2. In order to produce certain effects in the non-wovens 5 the feed rate of the feed rollers 6.1 and 6.2 and the feed rate of the feed belts 8.1 and 8.2 can also be operated with a certain difference in rates. For this, each feed roller 6.1 and 6.2 and each feed belt 8.1 and 8.2 is driven separately.

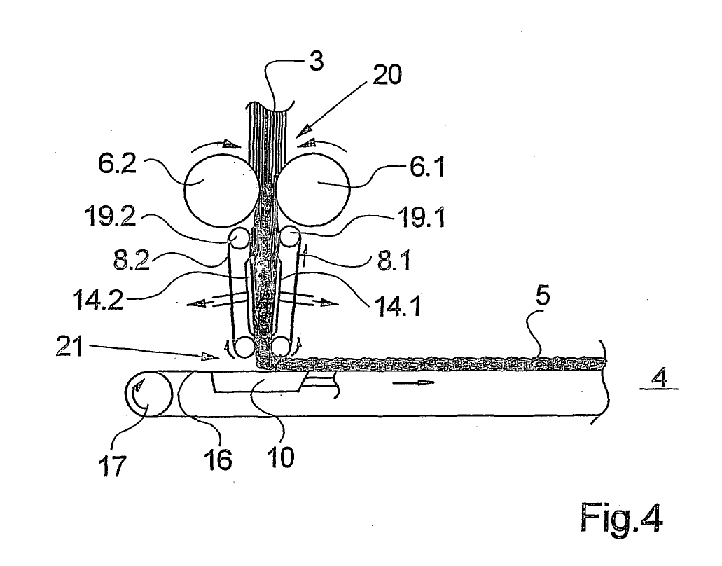

In FIG. 4 an additional embodiment of the device according to the invention is represented schematically where once again the representation of the spinning device of the draw-off device is omitted.

The spinning device, the draw-off device, and the represented perforated support 4 are identical to the previous embodiments.

To collect and lay the yarn sheet 3 two feed rollers 6.1 and 6.2 and feed belts 8.1 and 8.2 disposed after the feed rollers 6.1 and 6.2 are provided according to the embodiment of FIG. 4. The feed rollers 6.1 and 6.2 are disposed at a distance from one another so that a collecting gap 7 is formed. The feed rollers 6.1 and 6.2 have no suction device so that the yarn sheet 3 can be fed through the collecting gap 7 without laying it on the application surfaces of the feed rollers 6.1 and 6.2. Below the feed rollers 6.1 and 6.2 the feed belts 8.1 and 8.2 are each led between the drive rollers 19.1 and 19.2 and the deflecting rollers 9.1 and 9.2. The feed belts 8.1 and 8.2 are disposed relative to one another in such a manner that a collecting gap 7 formed between the feed belts 8.1 and 8.2 has a greater width on the side of the entrance 20 than at the exit 21. On their side facing the collecting gap 7 the feed belts 8.1 and 8.2 are each combined with a suction device 14.1 and 14.2. The feed belts 8.1 and 8.2 are thus essentially suctioned over the entire length of the collecting gap 7.

The collecting and laying of the individual fiber strands of the yarn sheet 3 is thus done essentially by the feed belts 8.1 and 8.2. In this case the feed rates of the feed rollers 6.1 and 6.2 and the feed belts 8.1 and 8.2 can be made very different. The non-woven 5 is produced essentially in the collecting gap 7 formed by the feed belts 8.1 and 8.2. By the extended suctioning of the feed belts 8.1 and 8.2 and the V-shaped arrangement of the feed belts 8.1 and 8.2 non-wovens with high densities can preferably be produced.

In order to be able to implement the process according to the invention, the yarn sheet could, in the embodiment represented in FIG. 4, be fed immediately through the draw-off device to the feed belts 8.1 and 8.2.

Furthermore, the feed rollers could be formed so that they can be moved in the horizontal direction in order to make possible the collecting of the yarn sheet predominantly on a drum. Thereby non-woven layings with lower non-woven masses can be produced.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus for spinning and forming a synthetic yarn sheet and forming the sheet into a non-woven mat, comprising
a melt spinning device for producing a downwardly advancing sheet of polymeric filaments,
a draw-off device for removing the sheet of filaments from the spinning device,
a pair of driven feed rollers forming a collecting gap therebetween and positioned so that the sheet of filaments enters and passes through the collecting gap and advances to a perforated support, and
a pair of driven feed belts disposed opposite to each other and positioned between the feed rollers and the perforated support so as to form an extension of the collecting gap and such that the feed belts cooperate with the feed rollers to advance the sheet of filaments toward the perforated support.

2. The apparatus of claim 1, wherein the feed rollers each comprise an air permeable outer jacket and a suction device in the interior thereof for suctioning air through a segmental circumferential section of the outer jacket, with the segmental circumferential sections of the rollers each facing an entrance portion of the collecting gap.

3. The apparatus of claim 2 wherein the suction devices are mounted in the respective feed rollers so that the suction devices can be displaced in the circumferential direction.

4. The apparatus of claim 2 wherein the outer jackets of the feed rollers comprise a surface which is more than 75% open.

5. The apparatus of claim 2 wherein each suction device has a suction power which is independently controllable.

6. The apparatus of claim 2 wherein each outer jacket comprises an exterior application surface and a plurality of interior partition walls, with the partition walls being disposed in such a manner that they are uniformly distributed about the circumference.

7. The apparatus of claim 1, wherein the feed rollers are mounted in such a manner that they can be displaced relative to each other to change the width of the collecting gap.

8. The apparatus of claim 1, wherein the feed rollers are mounted in such a manner that they can be displaced essentially in a vertical direction to change the spinning length between the spinning device and the collecting gap.

9. The apparatus of claim 1 wherein the feed belts are air permeable and endless, with each feed belt being positioned to encircle one of the feed rollers and an associated deflecting roller.

10. The apparatus of claim 9, wherein the deflecting rollers are positioned a short distance above the perforated support and define therebetween an exit to the collecting gap.

11. The apparatus of claim 9, wherein the feed belts are driven by the respective feed rollers.

12. The apparatus of claim 1, wherein the feed belts are positioned a short distance below the feed rollers, with each feed belt encircling a drive roller and a deflecting roller.

13. The apparatus of claim 12, further comprising a suction device positioned within each feed belt so as to draw a suction along the length of each side of the extension of the collecting gap.

14. The apparatus of claim 1, wherein the feed belts are positioned with respect to each other in such a manner that the extension of the collecting gap has a greater width at its upstream end than at its exit end.

15. The apparatus of claim 1, wherein the perforated support comprises a suction device in the area of the exit of the feed belts by means of which a transfer zone of the perforated support can be suctioned.

16. The apparatus of claim 13, wherein the perforated support comprises a running collecting belt.

17. A process for spinning a synthetic yarn sheet and forming the sheet into a non-woven mat, comprising the steps of
melt spinning a plurality of polymeric filaments in the form of a sheet of filaments which are downwardly advancing at a predetermined draw-off rate,
guiding the advancing sheet of filaments through a collecting gap formed by two feed belts disposed opposite to each other, while driving the feed belts in the advancing direction at a rate which is coordinated with the draw-off rate.

18. The process of claim 17 comprising the further step of drawing a suction on each side of the entrance of the collecting gap so as to cause a laying of the filament sheet on two application surfaces which border the collecting gap.

19. The process of claim 18, wherein the suction is drawn on each side of the entrance of the collecting gap at different intensities.

20. The process of claim 17, wherein the feed belts are driven at a surface speed which is less than the draw-off rate.
